(19) United States
(12) Patent Application Publication
(10) Pub. No.: US 2009/0108726 A1
(43) Pub. Date: Apr. 30, 2009

(54) INFRARED LIGHT SOURCE

(75) Inventors: Tetsuya WATANABE, Musashino-shi (JP); Hitoshi HARA, Musashino-shi (JP); Naoki KISHI, Musashino-shi (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 12/256,538

(22) Filed: Oct. 23, 2008

(30) Foreign Application Priority Data
Oct. 30, 2007 (JP) 2007-282126

(51) Int. Cl. H01K 1/30; H01K 1/38

(52) U.S. Cl. 313/113; 313/315; 313/110

(57) ABSTRACT

An infrared light source has a filament fabricated on a first substrate in the shape of a microbridge and energizes the filament so as to generate heat, thereby causing the filament to emit infrared radiation. The infrared light source has a second substrate that is bonded to the first substrate and seals the filament, and feedthrough electrodes that lead electrodes of the filament to the outside of the first substrate. Thereby, the function of the package is imparted to the device itself, to thus realize a highly-reliable device at low cost.

### TECHNICAL FIELD

The present disclosure relates to an infrared light source employed in an infrared gas analyzer that measures a gas concentration in the atmosphere by use of infrared radiation.

### RELATED ART

A non-dispersive Infrared gas analyzer (hereinafter referred to as an “NDIR gas analyzer”) which detects a rate of absorption by utilizing the fact that the wavelength of absorbed infrared radiation differs according to the type of a gas, to thus measure the concentration of a target gas, has been used for analyzing a gas.

The NDIR gas analyzer introduces a gas to be measured into a cell whose dimensions are specified; radiates infrared light to the gas; and measures the concentration of the gas component on the basis of the amount of intensity attenuation of a specific infrared waveband. For instance, when carbon dioxide is measured, it is better to measure the amount of transmission of infrared radiation having a wavelength of 4.25 μm or thereabouts.

FIG. 5 is a block diagram of the NDIR gas analyzer. In FIG. 5, the NDIR gas analyzer comprises a cell 100, an infrared light source 101, a wavelength selection filter 102, an infrared radiation detector 103, and a signal processing circuit (not shown) for processing a signal from the infrared radiation detector 103.

A gas to be measured is fed to the inside of the cell 100, and infrared light emitted from the infrared light source 101 and exposed to the gas enters the wavelength selection filter 102. Infrared light in the vicinity of a waveband corresponding to an absorption characteristic of the gas passes through the wavelength selection filter 102 and is detected by the infrared radiation detector 103. The signal processing circuit computes the concentration of the gas from the signal output from the infrared radiation detector 103.

FIG. 6A is a plan view of a related-art infrared light source 200, and FIG. 6B is a cross-sectional view taken along line A-A′ shown in FIG. 6A.

In FIGS. 6A and 6B, an SOI substrate 201 has a structure obtained by forming a monocrystal silicon layer 204 on a monocrystal silicon substrate 202 by way of silicon dioxide 203 serving as an insulation film. The monocrystal silicon substrate 202 is monocrystal silicon having surface direction [100], and the monocrystal silicon layer 204 is P-type silicon having a high concentration of impurity.

A filament 205 is patterned into a desired flat shape by means of subjecting the monocrystal silicon layer 204 to photoetching. In FIG. 6A, although the filament 205 is linear, the filament can assume an arbitrary shape, such as a meandering shape which is formed from a plurality of turned linear portions and a spiral shape, for the purpose of dispersing stress exerted on the filament 205 due to a temperature change to increase the life of the filament 205 or for increasing an area for emitting infrared radiation.

The area of the silicon dioxide 203 located below the filament 205 is eliminated into a square shape by means of photoetching, and the monocrystal silicon substrate 202 located in the area from which the silicon dioxide 203 has been removed is subjected to anisotropic etching, to thus form a trench 206. The filament 205 is fixed to both ends of the trench 206, to thus be formed into the shape of a microbridge levitated above the trench 206.

A silicon dioxide 208 formed on the monocrystal silicon layer 204 is etched, and electrodes 207a and 207b are formed so as to be able to energize the filament 205. When an electric current is caused to flow to the filament 205 by way of the electrodes 207a and 207b, the filament 205 generates heat, thereby emitting infrared radiation responsive to the temperature.

Since crystal grains are not present in the monocrystal silicon, a physical property of the filament 205 made of the monocrystal silicon layer 204 is stable. Further, the thickness of the filament 205 is determined by the thickness of the monocrystal silicon layer 204 of the SOI substrate 201, and hence the filament is considerably stable. Accordingly, an infrared light source that involves occurrence of considerably small age deterioration and an individual difference, such as variations in a relationship between load power and the intensity of the light source can be manufactured stably.

In short, an infrared gas analyzer exhibiting a stable relationship between load power and the intensity of the light source can be embodied.

[Patent Document 1] Japanese Patent Unexamined Application Publication No. 2001-221737

However, such an infrared light source has the following drawbacks:

In a case where the device shown in FIG. 6A is actually used, when the device is activated in the atmosphere, the reliability of the device deteriorates on account of a progress in oxidation, the corrosion of aluminum electrodes, intrusion of dust, and the like. For this reason, the device must be sealed in a package.

In relation to the package, consideration must be given to a window through which infrared radiation is emitted, hermeticity, exhaust heat, and the like, which becomes a contributor to domination of the cost and reliability of the device.

### SUMMARY

Exemplary embodiments of the present invention provide a infrared light source which realize a highly-reliable device at low cost by imparting the function of a package to the device itself.

A first aspect of the present invention is an infrared light source comprising:

a first substrate;

a filament which is formed on the first substrate and has a microbridge-shape;

a second substrate which is bonded to the first substrate to seal the filament; and

a feedthrough electrode which is formed in the first substrate and leads an electrode of the filament to the outside of the first substrate.

A second aspect of the present invention is based on the infrared light source of the first aspect and further characterized in that the second substrate has a recess at a position corresponding to the filament.

A third aspect of the present invention is based on the infrared light source of the first or second aspect and further characterized in that the second substrate has an antireflection film formed on interior and exterior sides of the second substrate.

A fourth aspect of the present invention is based on the infrared light source of any one of the first through third aspects and further characterized in that the first substrate has a recess which supports the filament over a hollow space and a reflection film formed on an interior surface of the recess.

A fifth aspect of the present invention is based on the infrared light source of any one of the first through fourth aspects and further characterized in that the first substrate is made of Pyrex (registered trademark) glass.

A sixth aspect of the present invention is based on the infrared light source of any one of the first through fifth aspects and further characterized in that the second substrate is made of silicon.

A seventh aspect of the present invention is based on the infrared light source of any one of the first through fifth aspects and further characterized in that the second substrate is made of calcium fluoride.

An eighth aspect of the present invention is based on the infrared light source of the sixth aspect and further characterized in that the first substrate and the second substrate are anodic-bonded together.

A ninth aspect of the present invention is based on the infrared light source of any one of the first through seventh aspects and further characterized by comprising:

a spacer disposed between the first substrate and the second substrate,

wherein the first substrate and the second substrate are bonded together by way of the spacer.

A tenth aspect of the present invention is based on the infrared light source of the ninth aspect and further characterized in that the spacer is made of silicon.

An eleventh aspect of the present invention is based on the infrared light source of any one of the first through tenth aspects and further characterized in that the first substrate has a through hole on which a metal film is formed through film growth, and the feedthrough electrode is formed by filling the through hole with metal by means of soldering or plating, or filling the through hole with a conductive paste.

Advantages yielded by typical embodiments of the present invention are described as follows.

The infrared light source of the present invention does not require a package. Hence, cost equivalent to the cost of the package can be curtailed, and cost required to assemble the package can also be lessened. Hence, lower cost can be fulfilled. Further, the infrared light source can be mounted directly on a printed board, or the like, by means of soldering.

A highly-reliable sealing structure made by anodic-bonding can be implemented.

Further, quick dissipation of heat by way of the feedthrough electrodes enables implementation of high-speed blinking.

Other features and advantages may be apparent from the following detailed description, the accompanying drawings and the claims.

### BRIEF DESCRIPTION OF THE DRAWINGS

FIGS. 1A and 1B are schematic views showing an embodiment of the present invention;

FIGS. 2A to 2L are process charts showing the embodiment of the present invention;

FIGS. 3A and 3B are schematic views showing another embodiment of the present invention;

FIGS. 4A to 4J are process charts showing the other embodiment of the present invention;

FIG. 5 is a schematic view of a related example; and

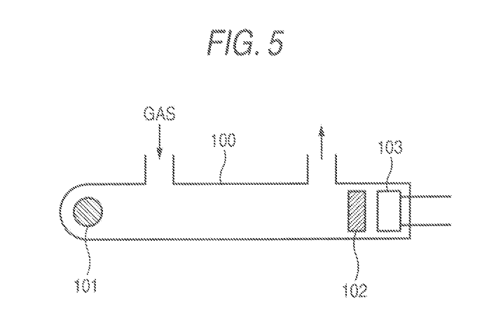

FIGS. 6A and 6B are schematic views of the related example.

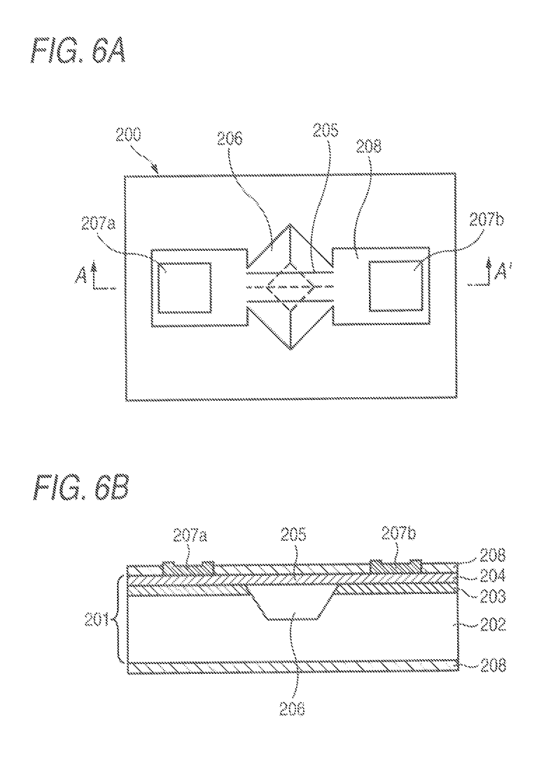

### DETAILED DESCRIPTION

An infrared light source of the present invention will be described hereunder by reference to the drawings.

### First Embodiment

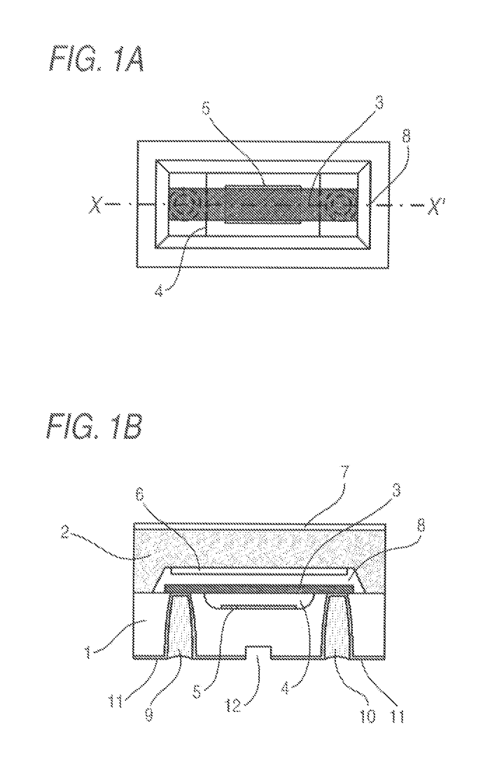

FIGS. 1A and 1B are structural drawings showing an embodiment of the infrared light source of the present invention. FIG. 1A is a plan view of the infrared light source of the present invention, and FIG. 1B is a cross-sectional view X-X′ shown in FIG. 1A.

A Pyrex (registered trademark) glass substrate is used as a first substrate (hereinafter called a “glass substrate 1”).

As shown in FIGS. 1A and 1B, in relation to the infrared light source, a silicon filament 3 is fabricated on the surface of the glass substrate 1. Feedthrough electrodes 9 and 10 are formed in the glass substrate 1.

The silicon filament 3 is fixed to areas of the glass substrate 1 corresponding to both ends of a recess (taken as a “recess 4 serving as a space located below the filament”) supporting the filament over a hollow space, by means of processing an area located below the filament.

In relation to the feedthrough electrodes 9 and 10, both ends of the silicon filament 3 are connected to the feedthrough electrodes 9 and 10 in order to lead electrodes of the silicon filament 3 to the outside of the glass substrate 1.

A reflection film 5 is formed on an interior surface of the recess 4 serving as a space below the filament.

A metal film 11 is formed on an exterior surface of the glass substrate 1 by means of film growth, and areas corresponding to the feedthrough electrodes 9 and 10 are electrically separated from each other by means of a groove 12 formed by means of dicing.

The silicon substrate is used as a second substrate (hereinafter taken as a “second silicon substrate 2”).

The glass substrate 1 is anodic-bonded, in a gas atmosphere such as nitrogen and krypton, to the second silicon substrate 2 in which a recess 8 that is to serve as a space above the filament is formed by processing.

The silicon filament 3 on the glass substrate 1 is sealed by the second silicon substrate 2 by means of anodic bonding of the glass substrate 1 to the second silicon substrate 2.

Antireflection films 6 and 7 made of a dielectric substance, such as a thermal oxide film and a nitride film, are formed on the interior and exterior sides of the second silicon substrate 2.

Operation of the infrared light source shown in FIGS. 1A and 1B is now described.

When a voltage is applied between the feedthrough electrodes 9 and 10, an electric current flows into the silicon filament 3, whereupon Joule's heat develops. Since the spaces are provided above and below the silicon filament 3, dissipation of heat induced by heat conduction becomes smaller than that induced when no spaces are provided above and below the silicon filament 3. Therefore, the temperature of the silicon filament 3 greatly increase, to thus give off light. The antireflection films 6 and 7 are provided on the second silicon substrate 2 by means of film growth, thereby lessening a loss caused by reflection. Thereby, the amount of transmission light can be increased. Light downwardly emitted from the silicon filament 3 is reflected by means of the reflection film 5 provided on the interior surface of the recess 4 serving as the space below the filament, to thus let light exit upwardly. This also leads to an increase in the amount of extracted light.

Since a package is not required, cost equivalent to the cost of the package can be curtailed, and cost required to assemble the package can also be lessened. Hence, lower cost can be fulfilled. Further, the infrared light source can be mounted directly on a printed board, or the like, by means of soldering.

A highly-reliable sealing structure made by anodic-bonding can be implemented.

When the infrared light source is applied to analysis of a gas, and the like, high-speed iteration of toggling operations is required. For this reason, rapid dissipation of heat from the silicon filament 3 also becomes crucial. The structure of the infrared light source of the present invention enables quick dissipation of heat by way of the feedthrough electrodes 9 and 10. Specifically, high-speed blinking can be implemented.

Since the internals space is filled with the gas atmosphere, such as nitrogen and krypton, by removal of oxygen and moisture, oxidation of the silicon filament 3 is prevented, and the longevity of the infrared light source can be attained.

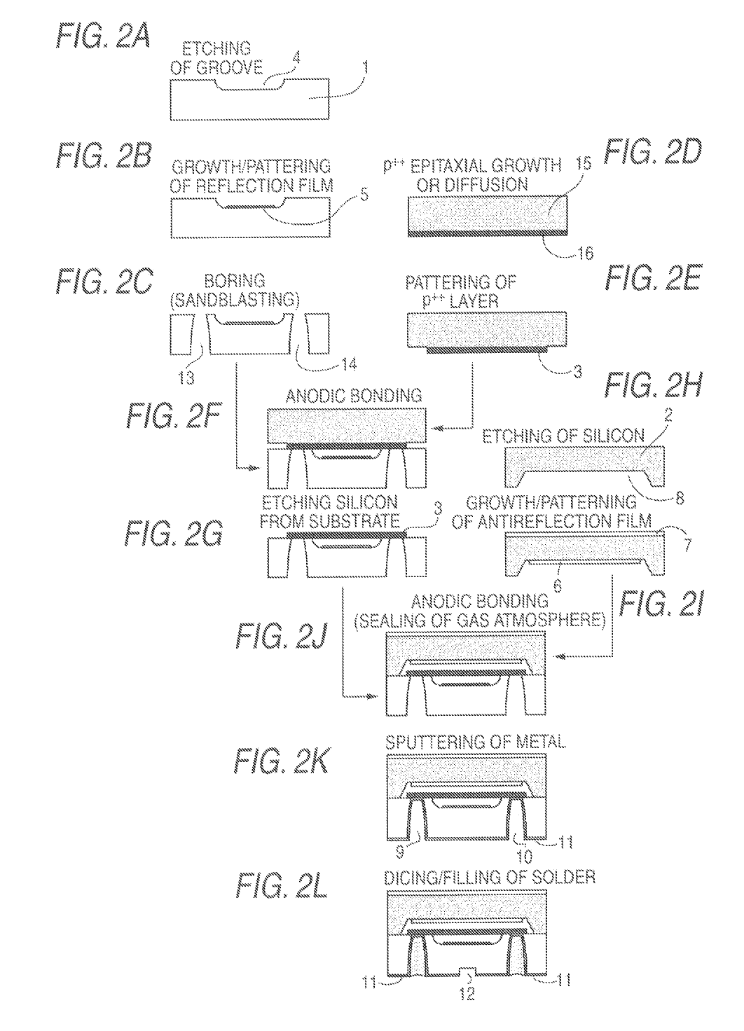

FIGS. 2A, 2B, 2C, 2D, 2E, 2F, 2G, 2H, 2I, 2J, 2K, and 2L are process charts showing an embodiment of a process of manufacturing the infrared light source of the present invention.

First, as shown in FIG. 2A, in the infrared light source, the recess 4 that is to serve as a space below the filament is formed in the glass substrate 1 by means of etching, and the like.

As shown in FIG. 2B, a metal film, such as Au, that is to serve as the reflection film 5 is formed on the interior surface of the recess 4 that is to serve as a space below the filament on the glass substrate 1, by means of film growth such as sputtering, and the thus-formed recess is etched.

As shown in FIG. 2C, through holes 13 and 14 that are to be processed into feedthrough electrodes are formed in the glass substrate 1 by means of sandblasting.

As shown in FIG. 2D, a heavily-boron-doped layer 16 is formed over the surface of the first silicon substrate 15, by means of epitaxial growth or diffusion.

As shown in FIG. 2E, the heavily-boron-doped layer 16 is etched away from an area except the area that is to be processed into the silicon filament 3 in a subsequent process.

Now, as shown in FIG. 2F, the first substrate underwent processing pertaining to a process shown in FIG. 2C and the first silicon substrate 15 underwent processing pertaining to a process shown in FIG. 2E are anodic-bonded together.

As shown in FIG. 2G, the thus-bonded substrates are etched by means of an alkali solution, such as hydrazine, TMAH, and KOH, to thus etch away the entire first silicon substrate 15 except the silicon filament 3 made of the heavily-boron-doped layer 16.

As shown in FIG. 2H, the recess 8 that is to serve as a space above the filament is formed in the second silicon substrate 2 by means of anisotropic etching using KOH and the like.

As shown in FIG. 2I, the antireflection films 6 and 7 are formed, through film growth, over the interior and exterior sides of the second silicon substrate 2 by means of thermal oxidation or the like, and the films are patterned.

Moreover, as shown in FIG. 2J, the first substrate underwent processing pertaining to a process shown in FIG. 2G and the second substrate underwent processing pertaining to a process shown in FIG. 2I are anodic-bonded together in the gas atmosphere, such as nitrogen and krypton.

As shown in FIG. 2K, the metal film 11 is formed, by means of sputtering, on the insides of the through holes 13 and 14 of the glass substrate 1 and the bottom surface of the glass substrate 1.

As shown in FIG. 2L, the groove 12 is formed in the bottom surface of the glass substrate 1 by means of dicing, thereby electrically isolating the areas corresponding to the feedthrough electrodes 9 and 10 from each other. Separation of the feedthrough electrodes 9 and 10 can also be carried out by means of photolithography, a hard mask, and the like.

Further, the feedthrough electrodes 9 and 10 can also be formed by filling the through holes 13 and 14, over which the metal film 11 is formed, with metal by means of soldering or plating or with a conductive paste.

### Second Embodiment

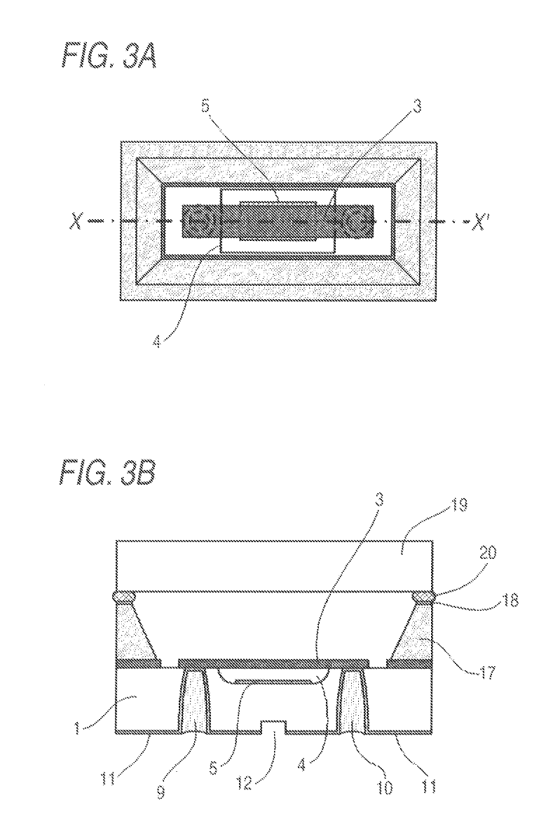

FIGS. 3A and 3B are schematic views showing another embodiment of the infrared light source of the present invention. FIG. 3A is a plan view of the other embodiment of the infrared light source of the present invention, and FIG. 3B is a cross-sectional view taken along line X-X′ shown in FIG. 3A. In the drawings, elements analogous to those shown in FIGS. 1A and 1B are assigned the same reference numerals.

The structure shown in FIGS. 1A and 1B cannot be applied to the light source that requires a wide wavelength transmission band. Accordingly, FIGS. 3A and 3B show a structure to which a window material having a wide transmission wavelength band, such as calcium fluoride (CaF₂), is to be bonded.

The Pyrex (registered trademark) glass substrate is used as the first substrate (hereinafter taken as a “glass substrate 1”).

As shown in FIGS. 3A and 3B, in the infrared light source, the silicon filament 3 is fabricated on the surface of the glass substrate 1. The feedthrough electrodes 9 and 10 are formed in the glass substrate 1.

The silicon filament 3 is fixed to areas of the glass substrate 1 corresponding to both ends of a recess (taken as a “recess 4 serving as a space located below the filament”) supporting the filament over a hollow space, by means of processing an area located below the filament.

In relation to the feedthrough electrodes 9 and 10, both ends of the silicon filament 3 are connected to the feedthrough electrodes 9 and 10 in order to lead electrodes of the silicon filament 3 to the outside of the glass substrate 1.

The reflection film 5 is formed on an interior surface of the recess 4 serving as a space below the filament.

The metal film 11 is formed on an exterior surface of the glass substrate 1 by means of film growth, and areas corresponding to the feedthrough electrodes 9 and 10 are electrically separated from each other by means of the groove 12 formed by means of dicing.

The calcium fluoride substrate is used as a second substrate [herein after taken as a “calcium fluoride (CaF₂) window material 19”).

The glass substrate 1 and the calcium fluoride (CaF₂) window material 19 are bonded together by way of a spacer 17. Silicon is used as the spacer 17.

The glass substrate 1 is anodic-bonded to the spacer 17 used for bonding the calcium fluoride (CaF₂) window material 19.

The silicon nitride (SiN) film 18 is a mask used when the spacer 17 is processed by means of anisotropic etching.

The spacer 17 is bonded to the calcium fluoride (CaF₂) window material 19 in the gas atmosphere, such as nitrogen and krypton, by means of the adhesive 20.

The glass substrate 1 and the spacer 17 are anodic-bonded together, and the spacer 17 and the calcium fluoride (CaF₂) window material 19 are bonded by means of the adhesive 20, whereby the silicon filament 3 on the glass substrate 1 is sealed by means of the calcium fluoride (CaF₂) window material 19, and the like.

Use of the spacer 17 enables assurance of a space above the silicon filament 3.

Operation of the infrared light source having a structure in which the window material shown in FIGS. 3A and 3B is bonded will now be described.

When a voltage is applied between the feedthrough electrodes 9 and 10, an electric current flows into the silicon filament 3, whereupon Joule's heat develops. Since the spaces are provided above and below the silicon filament 3, dissipation of heat induced by heat conduction becomes smaller than that induced when no spaces are provided above and below the silicon filament 3. Therefore, the temperature of the silicon filament 3 greatly increase, to thus give off light. Light downwardly emitted from the silicon filament 3 is reflected by means of the reflection film 5 provided on the interior surface of the recess 4 serving as the space below the filament, to thus let light exit upwardly. This also leads to an increase in the amount of extracted light.

Since a package is not required, cost can be curtailed by an amount corresponding to the package, and cost required to assemble the package can also be lessened. Hence, lower cost can be fulfilled. Further, the infrared light source can be mounted directly on a printed board, or the like, by means of soldering.

The glass substrate 1 and the spacer 17 are anodic-bonded together, and the spacer 17 and the calcium fluoride (CaF₂) window material 19 are bonded by means of the adhesive 20, whereby a highly-reliable sealing structure can be implemented.

When the infrared light source is applied to analysis of a gas, and the like, high-speed iteration of toggling operations is required. For this reason, rapid dissipation of heat from the silicon filament 3 also becomes crucial. The structure of the infrared light source of the present invention in which the window material is bonded enables quick dissipation of heat by way of the feedthrough electrodes 9 and 10. Specifically, high-speed blinking can be implemented.

Since the internals space is filled with the gas atmosphere, such as nitrogen and krypton, by removal of oxygen and moisture, oxidation of the silicon filament 3 is prevented, and the longevity of the infrared light source can be attained.

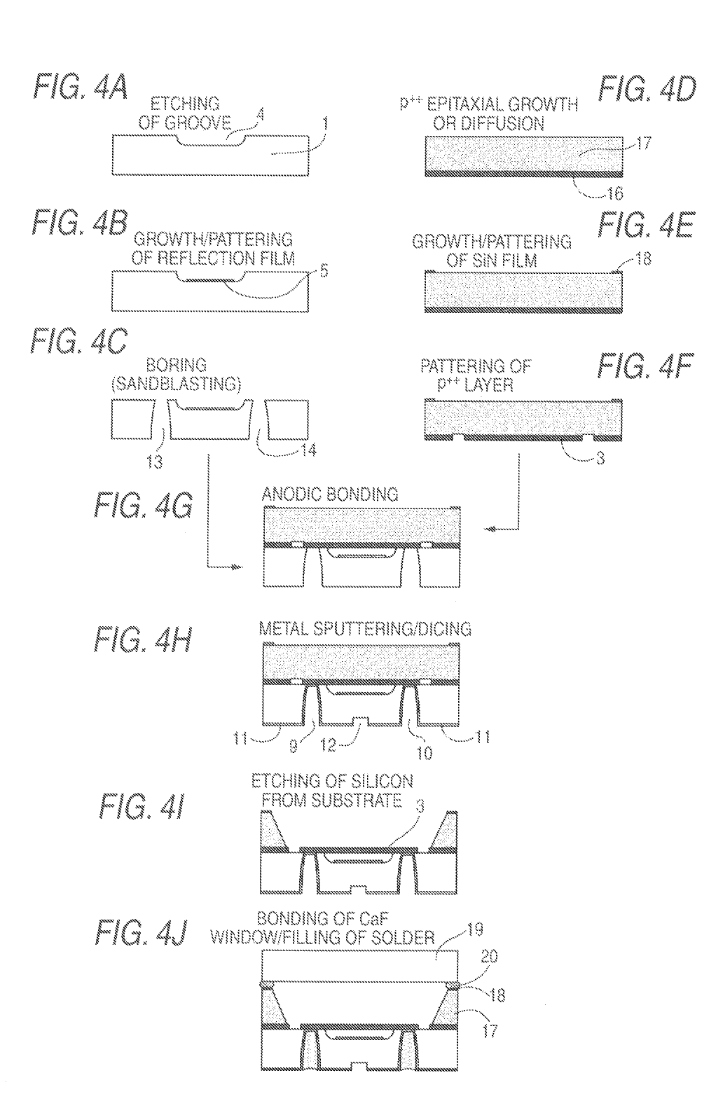

FIGS. 4A, 4B, 4C, 4D, 4E, 4F, 4G, 4H, 4I, and 4J are process charts showing an embodiment of a process of manufacturing the infrared light source of the present invention in which the window material is used. Elements analogous to those shown in FIGS. 2A through 2I are assigned the same reference numerals.

First, as shown in FIG. 4A, in the infrared light source, the recess 4 that is to serve as a space below the filament is formed in the glass substrate 1 by means of etching, or the like.

As shown in FIG. 4B, a metal film, such as Au, that is to serve as the reflection film 5 is formed on the interior surface of the recess 4 that is to serve as a space below the filament on the glass substrate 1, by means of film growth such as sputtering, and the thus-formed recess is etched.

As shown in FIG. 4C, through holes 13 and 14 that are to be processed into feedthrough electrodes are formed in the glass substrate 1 by means of sandblasting.

As shown in FIG. 4D, the heavily-boron-doped layer 16 is formed over the surface of the spacer 17, by means of epitaxial growth or diffusion.

As shown in FIG. 4E, the silicon nitride film (SiN) 18 is formed at both ends of an area on the back surface of the spacer 17 corresponding to the area of the surface where the heavily-boron-doped layer 16 is formed through epitaxial growth or diffusion, and the silicon nitride film is patterned.

As shown in FIG. 4F, the heavily-boron-doped layer 16 is etched away from an area except the area that is to be processed into the silicon filament 3 in a subsequent process.

Now, as shown in FIG. 4G, the first substrate underwent processing pertaining to a process shown in FIG. 4C and the spacer 17 underwent processing pertaining to a process shown in FIG. 4F are anodic-bonded together.

As shown in FIG. 4H, the metal film 11 is formed on the interior surfaces of the through holes 13 and 14 of the glass substrate 1 and the bottom surface of the glass substrate 1 through film grow, such as sputtering. After film growth processing, the groove 12 is formed in the bottom surface of the glass substrate 1 by means of dicing, thereby electrically isolating the areas corresponding to the feedthrough electrodes 9 and 10 from each other. Isolation of the feedthrough electrodes 9 and 10 can also be performed by means of photolithography, a hard mask, and the like.

As shown in FIG. 4I, the thus-bonded substrates are etched by means of an alkali solution, such as hydrazine, TMAH, and KOH, to thus selectively etch away the spacer 17.

As shown in FIG. 4J, the adhesive 20 is applied over the silicon nitride film (SiN) 18 on the spacer 17, to thus be bonded to the calcium fluoride (CaF₂) window material 19. Further, the feedthrough electrodes 9 and 10 can also be formed by filling the through holes 13 and 14, over which the metal film 11 is formed, with metal by means of soldering or plating or with a conductive paste.

In the infrared light source of the first embodiment, silicon is used for the window material in place of calcium fluoride, and hence a wavelength band is narrow. Therefore, the infrared light source can be used for the case where the type of a gas desired to be detected is determined as one. Further, silicon is less expensive than calcium fluoride. The thickness of the antireflection films 6 and 7 is changed in the process of FIG. 2I in accordance with wavelength bands of a gas desired to be detected, whereby measurement of the gas desired to be detected becomes feasible.

In the meantime, in the infrared light source of the second embodiment in which the window material is bonded, the calcium fluoride window material becomes more expensive than does silicon. However, calcium fluoride has a wider wavelength band, and hence various gases can be detected by one operation.

Specifically, when a gas desired to be detected is specified to one type, the inexpensive infrared light source of the first embodiment is selected. When types of gases desired to be detected are in numbers, selection of the infrared light source of the second embodiment capable of detecting a plurality of types of gases at one time is desired, though an increase in cost is incurred.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An infrared light source comprising:
a first substrate;
a filament which is formed on the first substrate and has a microbridge-shape;
a second substrate which is bonded to the first substrate to seal the filament; and
a feedthrough electrode which is formed in the first substrate and leads an electrode of the filament to the outside of the first substrate.

2. The infrared light source according to claim 1, wherein the second substrate has a recess at a position corresponding to the filament.

3. The infrared light source according to claim 1, wherein the second substrate has an antireflection film formed on interior and exterior sides of the second substrate.

4. The infrared light source according to claim 1, wherein the first substrate has a recess which supports the filament over a hollow space and a reflection film formed on an interior surface of the recess.

5. The infrared light source according to claim 1, wherein the first substrate is made of Pyrex (registered trademark) glass.

6. The infrared light source according to claim 1, wherein the second substrate is made of silicon.

7. The infrared light source according to claim 1, wherein the second substrate is made of calcium fluoride.

8. The infrared light source according to claim 6, wherein the first substrate and the second substrate are anodic-bonded together.

9. The infrared light source according to claim 1, further comprising:
a spacer disposed between the first substrate and the second substrate,
wherein the first substrate and the second substrate are bonded together by way of the spacer.

10. The infrared light source according to claim 9, wherein the spacer is made of silicon.

11. The infrared light source according to claim 1, wherein the first substrate has a through hole on which a metal film is formed through film growth, and the feedthrough electrode is formed by filling the through hole with metal by means of soldering or plating, or filling the through hole with a conductive paste.
